(19) United States
(12) Patent Application Publication
(10) Pub. No.: US 2009/0110341 A1
(43) Pub. Date: Apr. 30, 2009

(54) Bearing for a rotatable disk

(76) Inventors: Thomas Burgin, Lorrach (DE); Gotthard Liehr, Schopfheim (DE)

Correspondence Address: Horst M. Kaspar, 13 Forest Drive, Warren, NJ, 07059, US

(21) Appl. No.: 11/990,906

(22) PCT Filed: Aug. 19, 2006
(86) PCT No.: PCT/DE2006/001458

§ 371 Date: Feb. 22, 2008

(30) Foreign Application Priority Data
Aug. 22, 2005 (DE) 20 2005 013 214.4

(51) Int. Cl. F16C 19/12

(52) U.S. Cl. 384/620

(57) ABSTRACT

According to the invention, a bearing for a circular rotatable disc (4) on a support may be achieved by means of several, preferably three rollers (6) which roll on the circumference thereof which are positionally fixed but which may rotate on the support (3). The bearing is simpler and economical to produce is also reliable and hardly subject to wear. The bearing offers optimal guidance and support especially as a three-point bearing.

The invention relates to a bearing for a circular, rotatable disk, in particular for the bearing disk of a turnstile system for controlling the passage of persons, on which disk blocking elements are anchored which, by stepped rotation of the bearing disk, can be moved one after another out of a position which blocks the passage into a position which releases the passage.

Known bearings for rotatable disks are configured as central bearings which can be designed, for example, as sliding bearings or as roller bearings. For instance, CH-375 192 has disclosed a bearing for the rotatable disk of a machine tool, in which a total of three roller bearings are provided for complete mounting, namely an axial roller bearing which is arranged between the machine body and the underside of the drive wheel which is connected fixedly to the disk which is to be driven, a radial roller bearing which is inserted into the central hole of the drive wheel and has its inner seat on a sleeve or a projection of the machine body, and a further roller bearing which presses against the central bearing in interaction with a pressure disk and with the axial roller bearing.

PCT document WO 00/77338 A1 discloses a rotary lock, in which the rotatable carrier disk which carries the blocking arms is mounted on the fixed part of the rotary lock with the aid of a central roller bearing. DE 43 42 751 A1 and DE 44 45 698 C2 also disclose rotary locks or turnstile systems, in which the bearing plate which carries the blocking arms is mounted rotatably on the drive unit by a central bearing.

Central bearings have the disadvantage that they are very voluminous and complicated overall in their construction. The guidance and support of the rotatable disk are also not optimum.

It is an object of the invention to provide a bearing for a rotatable disk, which is less voluminous and simple and inexpensive in construction and at the same time affords satisfactory guidance and support for the disk.

According to the invention, this is achieved in that the disk is mounted rotatably on a carrier by means of a plurality of running rollers which can roll on its circumference and are fastened on said carrier in a stationary but rotatable manner. A bearing of this type is considerably less voluminous than the known central bearings. It is of substantially more spacesaving construction, in particular in the axial direction, and sufficient space is therefore saved on the rear side of the disk for the mounting of additional mechanisms. Here, however, it is very functionally reliable and is subject to scarcely any wear. Its construction is comparatively uncomplicated and does not require the high precision, as is indispensable in the case of the known roller bearings. The production is correspondingly less expensive.

It is advantageous if a running groove is provided in the circumferential face of the disk, into which running groove the running rollers engage and in which they can roll. This contributes to the functional reliability of the bearing.

The bearing is preferably configured as a three point bearing; in this way, the best guidance and support of the rotatable disk can be achieved. Certain tolerance fluctuations can be compensated for automatically in the process.

According to one preferred embodiment of the invention, the disk is mounted and guided on its circumference with the aid of three running rollers which are mounted on the carrier, for example a carrier plate, at an angular spacing of 120° in a stationary but rotatable manner. High stability is thus achieved by way of three small bearings.

In the following text, the invention will be described in greater detail using the example of a rotary lock and the appended drawing, in which:

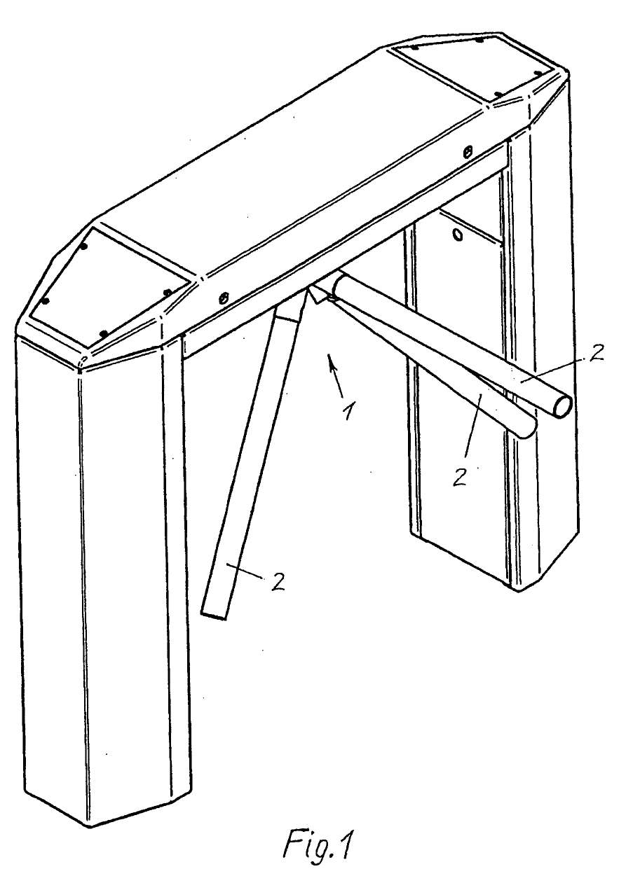

FIG. 1 shows the perspective view of a three-arm rotary lock, in which the invention can be used, for example,

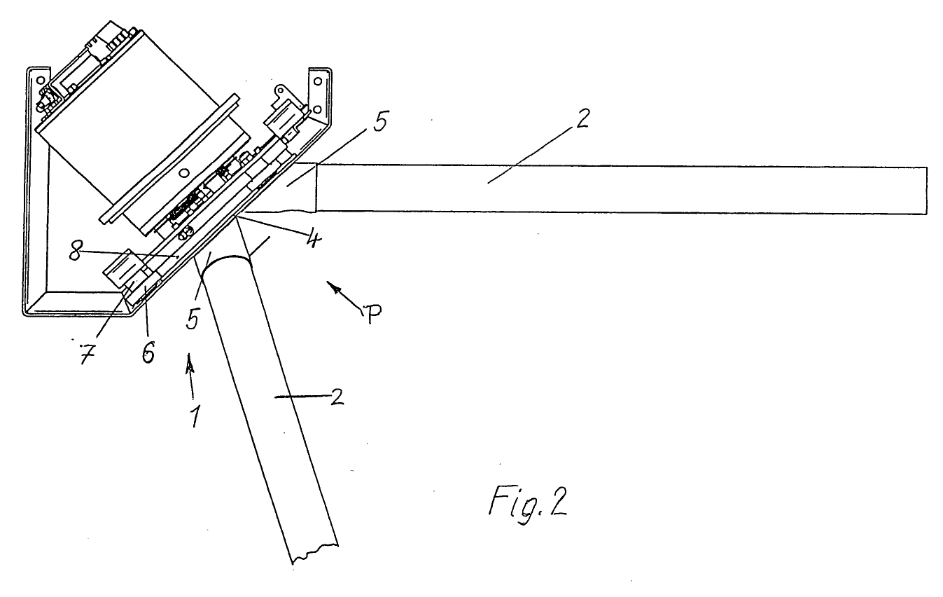

FIG. 2 shows the side view of the drive and blocking unit of a rotary lock according to FIG. 1 with the bearing according to the invention of the bearing disk,

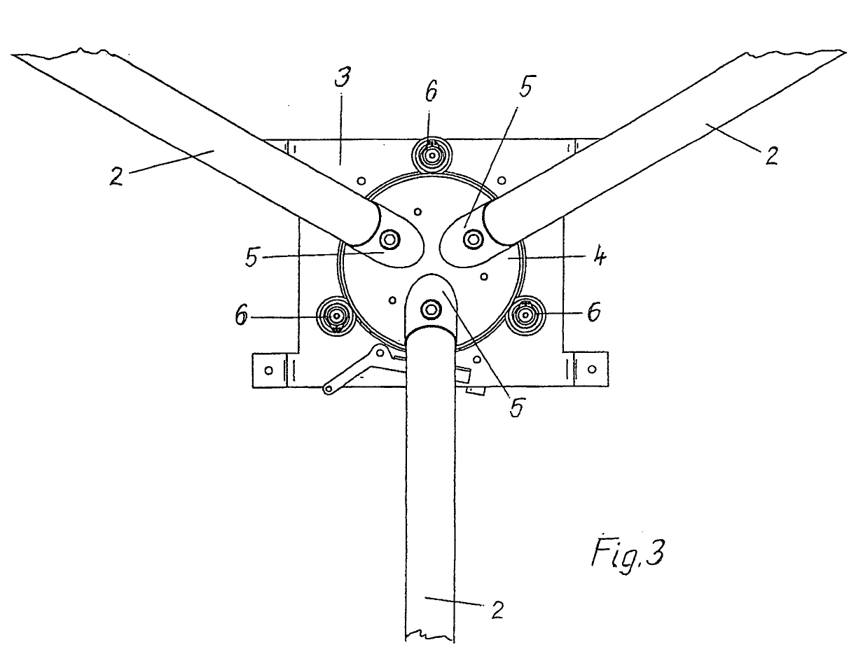

FIG. 3 shows the front view of the blocking unit in the direction of the arrow P in FIG. 2,

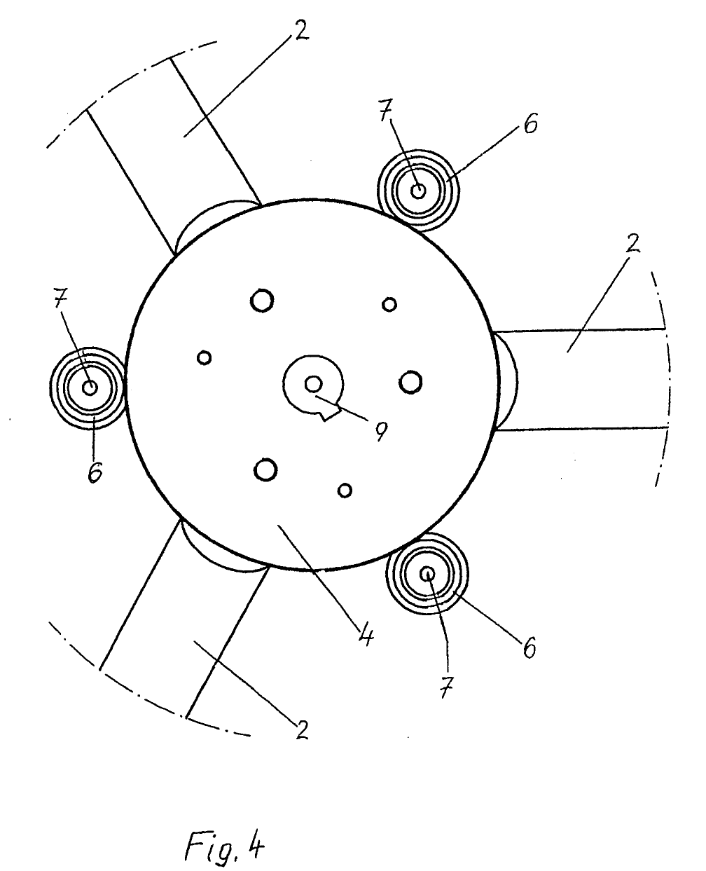

FIG. 4 shows a detail of the rear view of the blocking unit according to FIG. 3, and

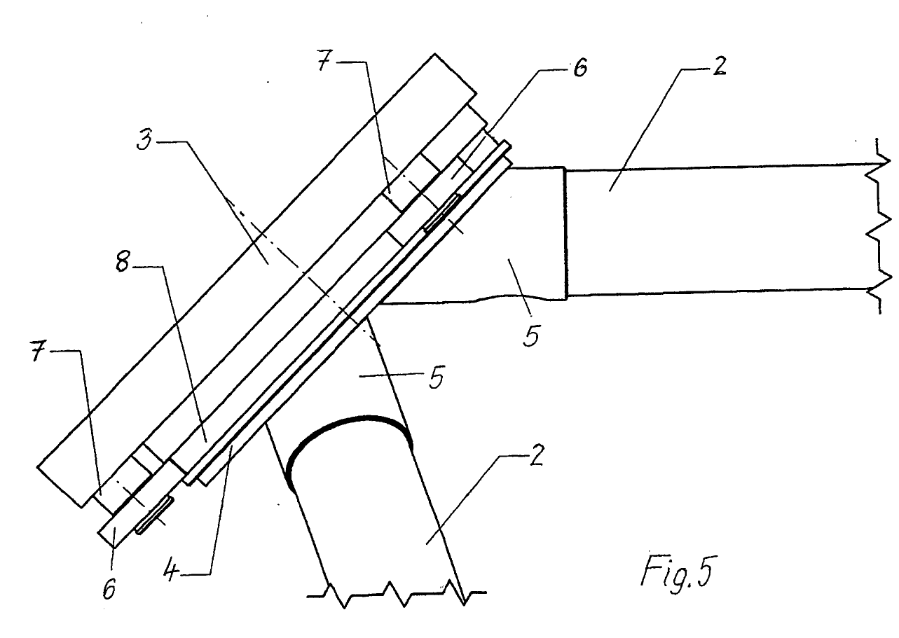

FIG. 5 shows a side view of the blocking unit according to FIGS. 3 and 4.

As an exemplary application for the present invention, FIG. 1 shows a three-arm rotary lock which is known per se and has a blocking unit 1 which can be rotated about a rotational axis which is inclined by approximately 45° with respect to the horizontal, from which blocking unit 1 three blocking elements 2 extend in the form of blocking arms 2 at an angle of in each case 120° with respect to one another. FIG. 2 shows the side view of the blocking unit 1 together with its drive unit. As can be seen more clearly from FIG. 3, the blocking unit 1 is mounted on a fixed carrier 3, a carrier plate 3 here, and the blocking arms 2 extend, at in each case an identical angle of 120° with respect to one another, from a circular bearing disk 4, where they are preferably held pivotably, preferably with the aid of receiving journals 5. At its outer circumference, the bearing disk 4 is mounted rotatably on the carrier plate 3 with the aid of a plurality of bearing rollers 6. This is preferably a three point bearing, that is to say three bearing rollers 6 are fastened on the carrier plate 3 via bearing journals 7 in a stationary but rotatable manner at an angular spacing of in each case 120°. A running groove 8 is provided in the bearing disk 4 on its outer circumferential face, into which running groove 8 the running rollers 6 engage and in which they can roll when the bearing disk 4 is driven by a drive motor (not shown) via a drive shaft 9 (see FIG. 4) and is rotated or turned about its center axis.

The above-described bearing is simple and inexpensive in its construction, it is relatively insusceptible to disruptions and is subject to as good as no wear. In the process it is very functionally reliable and, in particular in the preferred embodiment as a three point bearing, affords optimum guidance and support for the rotating bearing disk 4, and it requires considerably less space in comparison with the known central bearings.

The novel bearing has been described here using the example of a rotary lock, but it is not intended to be restricted thereto; rather, it can likewise be used in rotatable disks or plates in other application areas.

1. A bearing for a circular, rotatable disk, in particular for the bearing disk of a turnstile system for controlling the passage of persons, on which disk blocking elements are anchored which, by rotation of the bearing disk, can be moved one after another out of a position which blocks the passage into a position which releases the passage, characterized in that the disk (4) is mounted rotatably on a carrier (3) by means of a plurality of running rollers (6) which can roll on its circumference and are fastened on said carrier (3) in a stationary but rotatable manner.

2. The bearing as claimed in claim 1, characterized, in that a running groove (8) is provided in the circumferential face of the disk (4), into which running groove (8) the running rollers (6) engage and in which they can roll.

3. The bearing as claimed in claim 1, characterized in that it is a three point bearing.

4. The bearing as claimed in claim 1, characterized in that the disk (4) is mounted and guided on its circumference with the aid of three running rollers (6) which are mounted on the carrier (3) at an angular spacing of 120° in a stationary but rotatable manner.
